(19) United States
(12) Patent Application Publication
(10) Pub. No.: US 2002/0120726 A1
(43) Pub. Date: Aug. 29, 2002

(54) Method and system for providing a software license via the telephone

(75) Inventors: Arvind Padole, Redmond, WA (US); Eric Wong, Bellevue, WA (US); BIMAL MEHTA, SAMMAMISH, WA (US)

Correspondence Address: MERCHANT & GOULD, P.O. BOX 2903, MINNEAPOLIS, MN, 55402-0903, US

(73) Assignee: Microsoft Corporation

(21) Appl. No.: 09/792,608

(22) Filed: Feb. 23, 2001

(51) Int. Cl. G06F 15/177; G06F 15/16

(52) U.S. Cl. 709/222; 709/237

(57) ABSTRACT

A method and system for activating a software product over the telephone after installing the software product on a computer is disclosed. A user transmits an installation ID over the telephone to a customer service representative. Typically, the installation ID represents the product ID of the software product being installed and the hardware ID of the user's computer. The hardware ID is used to tie the hardware components of the user's computer to the installed software product so that the software product may not be copied to another computer (with different hardware components). The installation ID is encoded in base ten and encrypted before being transmitted to the customer service representative. The customer service representative connects with an activation authority, receives a confirmation ID and transmits the confirmation ID over the telephone to the user. The user receives the confirmation ID, inputs the confirmation ID into the computer so that the software product is licensed and activated for use. The confirmation ID is encoded in base ten and comprises the license to use the software product. The confirmation ID may comprise an expiry date for the license so that the software product may be licensed on a subscription basis. The confirmation ID may comprise a signature identifying that the license originates from a valid source and has not been tampered with.

### TECHNICAL FIELD

The invention generally relates to licensing a software program module, and even more particularly, relates to methods and systems for providing a software license via the telephone.

### BACKGROUND

Computer software is a unique consumer product in that the same product can be replicated many times after being sold. Once a software product is sold, typically as software code on a computer-readable disk, the purchaser can easily copy the code to other computer-readable media thereby replicating the same product many times over.

This characteristic of software can be a tremendous benefit in terms of lowering manufacturing costs and facilitating distribution. For instance, easy replication allows a software manufacturer to distribute one physical copy of the software product and sell a multi-seat license that legally empowers the purchaser to install the software product on many different computers.

Unfortunately, this benefit comes at a cost of open abuse. One well-known abuse is piracy. An unscrupulous party can obtain a copy of the object code (legally or illegally) and then illicitly replicate and resell pirated copies of the product. Software companies attempt to monitor piracy activities, but detection is often difficult. Moreover, even when improper activity is detected, enforcement and legal recourse is often unavailable from a practical standpoint, particularly since much of the abuse occurs in foreign lands.

The computer software industry estimates billions of dollars are lost each year due to piracy and other illicit uses. To eliminate some of these losses, software manufacturers may require individual licenses rather than multi-seat licenses. These individual licenses are entered into before allowing a software product to operate. A user installing a software product with an individual license typically needs to activate the software product before using it.

Activation of the software product may be accomplished by telephoning a customer service representative and verbally transmitting an installation ID (a product ID and a hardware ID). In return, the customer service representative verbally transmits a confirmation ID for the user to enter into his computer to activate the software product.

Although verbal licenses work fairly well, there are some problems. The confirmation ID and the installation ID were base 24 encoded in Microsoft's “OFFICE 9” and, thus, included characters such as A, B, C, D, etc. These characters were difficult to pronounce and understand over the telephone resulting in errors and a lengthy call time for activating the software product, particularly for non-English speaking purchasers and customer service representatives. Another problem with a telephone license is security. Still another problem with a telephone license is that detecting errors in transcribing the confirmation ID or product ID is often difficult because these IDs are often quite lengthy.

Accordingly, there remains a need for improved telephone licensing solutions for software products.

### SUMMARY OF THE INVENTION

The present invention meets the above-described needs by providing a method and system for activating a software product over the telephone after installing the software product on a computer is disclosed. A user transmits an installation ID over the telephone to a customer service representative. Typically, the installation ID represents the product ID of the software product being installed and the hardware ID of the user's computer. The hardware ID is used to tie the hardware components of the user's computer to the installed software product so that the software product may not be copied to another computer (with different hardware components). The installation ID is encoded in base ten and encrypted before being transmitted to the customer service representative. The customer service representative connects with an activation authority, receives a confirmation ID and transmits the confirmation ID over the telephone to the user. The user receives the confirmation ID, inputs the confirmation ID into the computer so that the software product is licensed and activated for use. The confirmation ID is encoded in base ten and comprises the license to use the software product. The confirmation ID may comprise an expiry date for the license so that the software product may be licensed on a subscription basis. The confirmation ID may comprise a signature identifying that the license originates from a valid source and has not been tampered with. The installation ID and confirmation ID may each comprise at least one checksum for locating errors. The installation ID and confirmation ID may have at least one validation number. When decoded and decrypted, the validation number will be located in a specific location to enhance security of the installation ID and confirmation ID.

That the invention improves over the drawbacks of prior art and accomplishes the advantages described above will become apparent from the following detailed description of the exemplary embodiments and the appended drawings and claims.

### BRIEF DESCRIPTION OF THE FIGURES

FIG. 1 is a block diagram of an exemplary personal computer system on which a software product may be installed.

FIG. 2 is an illustration of an exemplary anti-piracy system that facilitates telephone activation of a software product with an activation authority.

FIG. 3 is a flow diagram illustrating steps in a method for activating via the telephone a software product for installation and use on a computer in accordance with an embodiment of the present invention.

### DETAILED DESCRIPTION OF EMBODIMENTS OF THE INVENTION

An embodiment of the present invention will be functional with the “OFFICE XP” suite of program modules marketed by Microsoft Corporation of Redmond, Wash. Briefly described, in one embodiment, the invention is a method and system for activating a software product over the telephone after installing the software product on a computer is disclosed. A user transmits an installation ID over the telephone to a customer service representative. Typically, the installation ID represents the product ID of the software product being installed and the hardware ID of the user's computer. The hardware ID is used to tie the hardware components of the user's computer to the installed software product so that the software product may not be copied to another computer (with different hardware components). The installation ID is encoded in base ten and encrypted before being transmitted to the customer service representative. The customer service representative connects with an activation authority, receives a confirmation ID and transmits the confirmation ID over the telephone to the user. The user receives the confirmation ID, inputs the confirmation ID into the computer so that the software product is licensed and activated for use. The confirmation ID is encoded in base ten and comprises the license to use the software product. The confirmation ID may comprise an expiry date for the license so that the software product may be licensed on a subscription basis. The confirmation ID may comprise a signature identifying that the license originates from a valid source and has not been tampered with. The installation ID and confirmation ID may each comprise at least one checksum for locating errors. The installation ID and confirmation ID may have at least one validation number. When decoded and decrypted, the validation number will be located in a specific location to enhance security of the installation ID and confirmation ID.

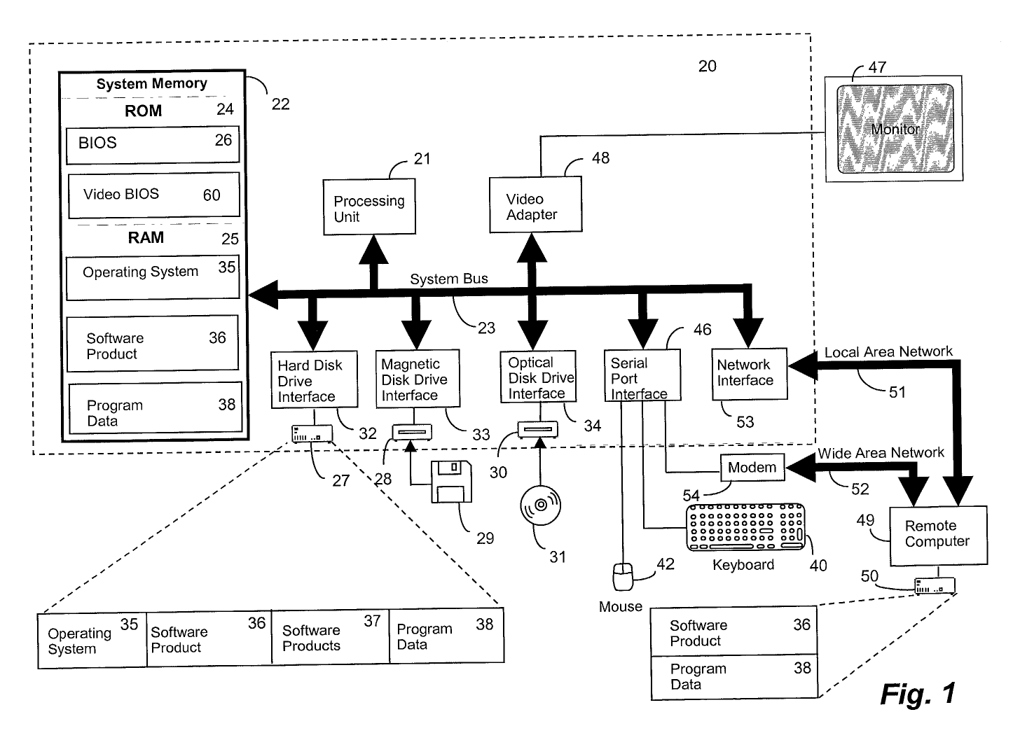

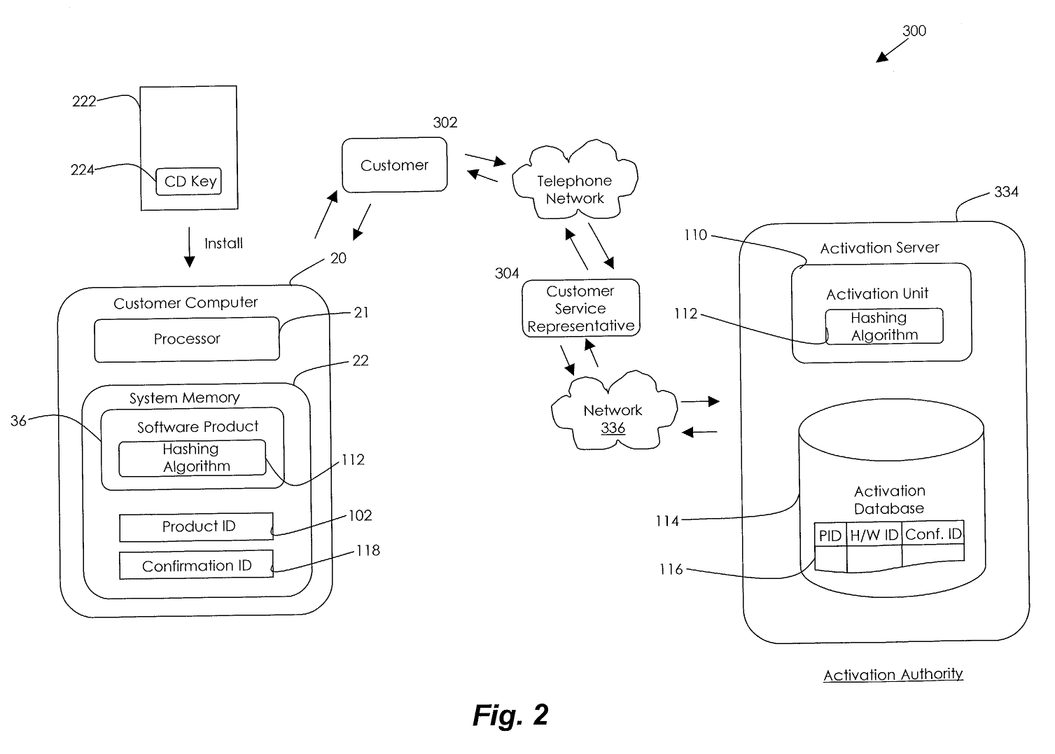

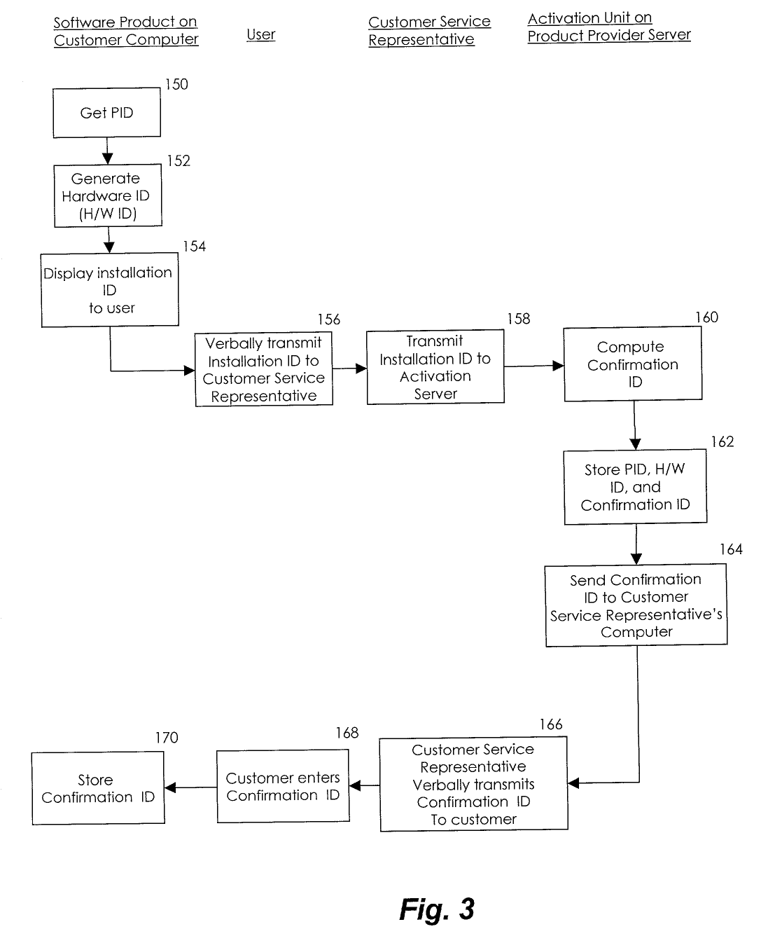

Before describing embodiments of the present invention, a description of an exemplary personal computer system on which a software product may be installed will be provided below in reference to FIG. 1. Following the description of FIG. 1 is a detailed description of providing a telephone license for a software product in reference to FIGS. 2-3.

FIG. 1 and the following discussion are intended to provide a brief, general description of an exemplary personal computer system on which a software product may be installed. Those skilled in the art will recognize that software products may include routines, programs, components, data structures, etc. that perform particular tasks or implement particular abstract data types. Moreover, those skilled in the art will appreciate that the invention may be practiced with other computer system configurations, including hand-held devices, multiprocessor systems, microprocessor-based or programmable consumer electronics, minicomputers, mainframe computers, and the like. The invention may also be practiced in distributed computing environments where tasks are performed by remote processing devices that are linked through a communications network. In a distributed computing environment, software products may be located in both local and remote memory storage devices.

With reference to FIG. 1, an exemplary system for implementing the invention includes a conventional personal computer 20, including a processing unit 21, a system memory 22, and a system bus 23 that couples the system memory to the processing unit 21. The system memory 22 includes read only memory (ROM) 24 and random access memory (RAM) 25. A basic input/output system 26 (BIOS), containing the basic routines that help to transfer information between elements within the personal computer 20, such as during start-up, is stored in ROM 24. A video BIOS 60 may also be stored in ROM 24. The personal computer 20 further includes a hard disk drive 27, a magnetic disk drive 28, e.g., to read from or write to a removable disk 29, and an optical disk drive 30, e.g., for reading a CD-ROM disk 31 or to read from or write to other optical media. The hard disk drive 27, magnetic disk drive 28, and optical disk drive 30 are connected to the system bus 23 by a hard disk drive interface 32, a magnetic disk drive interface 33, and an optical drive interface 34, respectively. The drives and their associated computer-readable media provide nonvolatile storage for the personal computer 20. Although the description of computer-readable media above refers to a hard disk, a removable magnetic disk and a CD-ROM disk, it should be appreciated by those skilled in the art that other types of media which are readable by a computer, such as magnetic cassettes, flash memory cards, digital video disks, Bernoulli cartridges, and the like, may also be used in the exemplary operating environment.

A number of software products may be stored in the drives and RAM 25, including an operating system 35, a software product 36, such as Microsoft's “OFFICE XP” suite of application program modules, other software products 37, and program data 38. A user may enter commands and information into the personal computer 20 through a keyboard 40 and pointing device, such as a mouse 42. Other input devices (not shown) may include a microphone, joystick, game pad, satellite dish, scanner, or the like. These and other input devices are often connected to the processing unit 21 through a serial port interface 46 that is coupled to the system bus, but may be connected by other interfaces, such as a game port or a universal serial bus (USB). A monitor 47 or other type of display device is also connected to the system bus 23 via an interface, such as a video adapter 48. In addition to the monitor, personal computers typically include other peripheral output devices (not shown), such as speakers or printers.

The personal computer 20 may operate in a networked environment using logical connections to one or more remote computers, such as a remote computer 49. The remote computer 49 may be a server, a router, a peer device or other common network node, and typically includes many or all of the elements described relative to the personal computer 20, although only a memory storage device 50 has been illustrated in FIG. 1. The logical connections depicted in FIG. 1 include a local area network (LAN) 51 and a wide area network (WAN) 52. Such networking environments are commonplace in offices, enterprise-wide computer networks, Intranets and the Internet.

When used in a LAN networking environment, the personal computer20 is connected to the LAN 51 through a network interface 53. When used in a WAN networking environment, the personal computer 20 typically includes a modem 54 or other means for establishing communications over the WAN 52, such as the Internet. The modem 54, which may be internal or external, is connected to the system bus 23 via the serial port interface 46. In a networked environment, program modules depicted relative to the personal computer 20, or portions thereof, may be stored in the remote memory storage device. It will be appreciated that the network connections shown are exemplary and other means of establishing a communications link between the computers may be used.

Providing a Software License via the Telephone

As described above in the Background, delivering secure and flexible telephone licenses for a software product has been problematic in the past due to numerous reasons such as the licenses containing letters. Letters are sometimes difficult to pronounce and comprehend via the telephone, particularly for non-English speaking customers and customer service representatives. Additionally, the call times for providing these software licenses were oftentimes longer than necessary due to mistakes being made in transmitting the license over the telephone. Still other problems with telephone licenses include security issues and the possibility of a hacker illicitly generating a telephone license that may be used with illegally copied software.

FIG. 2 illustrates an exemplary anti-piracy system 300 that facilitates telephone activation of a software product with an activation authority for installation and use on a particular computer 20. The system 300 includes a customer computer 20 and an activation server 334, which resides at the activation authority remote from the customer. A customer (or user) 302 enters information into the computer 20 and connects via a telephone and a telephone network to a customer service representative 304. The customer service representative 304 operates a computer that is interconnected to the activation server 334 by a network 336 to provide data communication.

For discussion purposes, the customer computer 20 is described as a personal computer, such as a desktop or portable computer. However, as used herein, the term “computer” is intended to mean essentially any type of computing device or machine that is capable of running a software product, including such devices as communication devices (e.g., pagers, telephones, electronic books, electronic magazines and newspapers, etc.) and personal and home consumer devices (e.g., handheld computers, Web-enabled televisions, home automation systems, multimedia viewing systems, etc.). Within the described context, the network 336 is representative of an Internet or intranet, or a local or wide area network. However, the network 336 may be implemented in many different forms, including both wire-based networks (e.g., cable, telephone, fiber optic, etc.) and wireless networks (e.g., RF, satellite, microwave, etc.)

With reference again to FIG. 2, the customer 302 purchases a software product for running on the computer 20. In this illustration, the software product is in the form of a shrink-wrap product 222 having a software program stored on a transportable computer-readable medium, such as a CD-ROM or floppy diskette. In other implementations, the software product may be delivered electronically over a network. The customer loads the software product onto the computer 20 as a software product (program) 36 stored in system memory 22.

During installation, the customer is prompted to enterthe product key of the software product. The product key in this case is the CD key printed on label 224 of the shrink-wrap package. The customer enters the product key 102, which is associated with the software product 36. Additionally, another portion of the product ID (PID) is already included in the software product 36 and the software product combines the two portions, along with other information, into a product ID that is unique to the specific installation.

As part of the installation process, the customer activates the software product with the activation authority via the telephone. This authority might be, for example, the product manufacturer or an authorized third party. The activation process forces the customer to activate the software product for installation and use on a specific computer.

FIG. 3 shows steps in a method for activating via the telephone the software product 36 for installation and use on the computer 20. The method is described with continuing reference to FIG. 2. At step 150, the software product 36 obtains its product ID (PID) 102. As an example, the product ID comprises a 5-digit MPC (manufacturer's product code) value for the software product, a 3-digit channel ID indicating a place of manufacture, and a 7-digit serialized number that is incremented with each product. Typically, after the customer enters the product key 224, the product ID is obtained by the software product 36 from the data derived from the product key and a portion that is stored in the software product.

The software product 36 generates a hardware ID (H/W ID) that identifies a set of hardware components that make up the customer's computer 20 (step 152). The hardware ID is a multi-bit value having at least one bit representing each of the corresponding system components. As an example, the software product generates a 5-bit hardware ID that includes a single bit for each of five system components: BIOS 26, VBIOS 60, RAM 25, hard disk drive 27, and floppy disk drive 28. A bit for a given system component can be derived in different ways, such as performing a modulo operation on a chunk of the BIOS, or on the hard disk drive's serial number.

It is noted that other hardware components may be used. For instance, many computers are equipped with a network card with a unique 128-bit address. A bit for the hardware ID can be derived from this global network card address. Moreover, more than, or fewer than, five system components may be used to derive the hardware ID. For example, in one embodiment, the hardware ID is 64 bits in length and identifies ten different hardware components of the customer's computer. The hardware ID is used to ensure that the software product is not copied from one computer to another by tying the software product to certain hardware components.

The software product concatenates the product ID with the hardware ID to produce an installation ID, and displays the value to the user (step 154). Of course, the installation ID may include other information needed by the activation authority. Typically, the installation ID will be encrypted and encoded before being displayed to the customer. In one embodiment, the software product supports an activation pilot with a graphical user interface (UI) dialog window asking the customer to call a customer service representative at the activation authority. The UI window lists the installation ID (product ID plus the hardware ID), and includes an entry box to enter the confirmation ID given by the customer service representative over the phone.

The customer 302 telephones a customer service representative 304 and verbally transmits the installation ID to the customer service representative over the telephone (step 156).

The customer service representative 304 transmits the installation ID over the network 336 to the activation server 334 (step 158).

The activation server 334 has an activation unit 110 to assign a confirmation ID to the software product on the customer's computer. The activation unit 110 computes the confirmation ID from the installation ID (step 160 in FIG. 3). In the illustrated implementation, the activation unit 110 employs a hashing algorithm 112 to compute a hash value of the installation ID. The activation server 334 also maintains a database 114 to store the product ID, hardware ID, and confirmation ID (step 162 in FIG. 3). Preferably, these IDs are correlated in a table or other data record 116.

The activation server 334 returns the confirmation ID over the network 336 for display on the customer service representative's computer (step 164 in FIG. 3). The customer service representative verbally transmits to the customer the confirmation ID over the telephone (step 166) and the customer enters the confirmation ID via the UI window (step 168). The confirmation ID 118 is stored locally in the system memory 22 of the customer computer 20, where it is accessible by the software program 36 (step 170 in FIG. 3). The program 36 is also equipped with the same hashing algorithm 112 as found in the activation unit 110 at the activation server 334. The confirmation ID is used when the software product is started to ensure that the customer has a valid license to use the software product.

In a preferred embodiment of the present invention, the installation ID and confirmation ID are encrypted before being transmitted over the telephone. Moreover, in a preferred embodiment, the installation ID and confirmation ID are encoded in base 10 before being transmitted over the telephone. Encoding the installation ID and confirmation ID in base 10 removes all letters from these IDs. Therefore, customers and customer service representatives avoid the problems associated with pronouncing and comprehending letters and activation call times are reduced. Encrypting reduces the possibility for hackers to gain access to these IDs.

In one embodiment, the confirmation ID may include an expiry date for the software product license. As will be further described below, different types of licenses may be granted and some of these licenses may include an expiry date.

In another embodiment, the confirmation ID includes a signature from the activation authority. The signature is used by the software product to authenticate that the telephone license was received from a proper activation authority and has not been tampered with.

The installation ID and confirmation ID may also include at least one checksum to help locate errors. Thus, if there is a problem in the installation ID or the confirmation ID, the customer service representative may quickly locate where a potential problem is and correct the problem thereby reducing activation call times.

Magic numbers are inserted in the specific bit locations while generating the installation ID and confirmation ID and are validated when the installation ID or the confirmation ID is decoded. These magic numbers are numbers decided upon by the software product manufacturer or activation authority. These magic numbers provide another security and error detection mechanism.

In a preferred embodiment of the invention, there are several different license types that may be granted for a software product: activation, subscription, trial, voluntary or free. An activation license requires the software product to be activated before use (although it may operate a few times initially before locking itself) and then does not require that the license be renewed. A subscription license is for a limited time period with an expiry date (but may be renewed by paying another license fee). A trial license allows free use of the software product for a limited period of time and is typically non-renewable. A voluntary license allows the software product to operate (without activation). A free license does not require a license fee or activation of the software product. In one embodiment of the present invention, the installation ID is of variable length depending upon the license type: activation, subscription, trial, voluntary or free.

It should be understood from the foregoing description that the present invention provides a method and system for efficiently providing a secure and flexible telephone license to a software user.

It should also be understood from the foregoing description that the installation ID and confirmation ID are encoded in base 10, rather than base 24 as in the prior art. Therefore, users and operators do not need to read letters over the telephone. The installation ID may be encrypted and include a checksum. The confirmation ID may include an expiration date, be encrypted, include a checksum and include a signature.

It should also be understood from the foregoing description that the present invention reduces call time by sending a minimum number of digits over the phone without compromising on security or flexibility. The present invention also reduces call time because there are less errors involved in the licensing process.

It should be understood that the foregoing pertains only to the preferred embodiments of the present invention, and that numerous changes may be made to the embodiments described herein without departing from the spirit and scope of the invention.

We claim:

1. A method for activating a software product over the telephone after installing the software product on a computer, comprising the steps of:
transmitting an installation ID over the telephone to a customer service representative, wherein the installation ID is associated with the software product and is encoded in base ten;
receiving a confirmation ID from the customer service representative, wherein the confirmation ID comprises a license to use the software product and is encoded in base ten; and
entering the confirmation ID into the computer, wherein the software product is licensed and activated for use.

2. The method of claim 1 wherein the installation ID is encrypted by the software product before being transmitted.

3. The method of claim 2 wherein the installation ID comprises a product ID associated with the software product and a hardware ID associated with the computer.

4. The method of claim 3 wherein the confirmation ID comprises an expiry date for the license.

5. The method of claim 4 wherein the confirmation ID comprises a signature identifying that the license originates from a valid source and has not been tampered with.

6. The method of claim 5, wherein the installation ID and confirmation ID comprise at least one checksum for locating errors.

7. The method of claim 6, wherein the installation ID and confirmation ID comprise at least one validation number, wherein, when decoded and decrypted, the installation ID comprises the at least one validation number in a predetermined location, and, wherein, when decoded and decrypted, the confirmation ID comprises the at least one validation number in a predetermined location.

8. The method of claim 7, wherein the installation ID is of variable length depending upon the type of license.

9. An installation ID for use with an activation system for activating a software product installed on a computer and installing a license for the software product on the computer, wherein the installation ID comprises:
a product ID associated with the software product;
a hardware ID associated with a plurality of hardware components of the computer; and
wherein the installation ID is encoded in base 10 and encrypted.

10. The installation ID of claim 9 further comprising a checksum.

11. The installation ID of claim 10 further comprising at least one validation number, wherein, when decoded and decrypted, the at least one validation number is located at a specific location within the decoded and decrypted installation ID.

12. The installation ID of claim 11, wherein the installation ID is of a variable length depending upon the license type to be installed on the computer.

13. The installation ID of claim 12, wherein the installation ID is verbally transmitted to a customer service representative so that a license for the software product may be obtained.

14. A confirmation ID for use with an activation system for activating a software product installed on a computer and installing a license for the software product on the computer, wherein the confirmation ID comprises:
a license associated with the software product,
wherein the installation ID is encoded in base 10 and encrypted.

15. The confirmation ID of claim 14 further comprising a checksum.

16. The confirmation ID of claim 15 further comprising at least one validation number, wherein, when decoded and decrypted, the at least one validation number is located at a specific location within the decoded and decrypted confirmation ID.

17. The confirmation ID of claim 16, wherein the confirmation ID is verbally transmitted to a user so that a license for the software product may be obtained by entering the confirmation ID into the computer.

18. The confirmation ID of claim 17 further comprising a signature identifying that the license originates from a valid source and has not been tampered with.
